(19) United States
(12) Patent Application Publication
(10) Pub. No.: US 2007/0132695 A1
(43) Pub. Date: Jun. 14, 2007

(54) LIQUID CRYSTAL DISPLAY AND METHOD THEREOF

(75) Inventor: Tae-Sung KIM, Suwon-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/610,160

(22) Filed: Dec. 13, 2006

(30) Foreign Application Priority Data
Dec. 14, 2005 (KR) 10-2005-0123129

(51) Int. Cl. G09G 3/36

(52) U.S. Cl. 345/98

(57) ABSTRACT

A liquid crystal display (“LCD”) includes a liquid crystal panel assembly including a plurality of pixels, each having first and second subpixels, an image signal converter dividing an input image signal having a first bit number into a first pre-signal and a second pre-signal each having a second bit number less than the first bit number, and converting the first pre-signal having a first bit number into a first output image signal having the second bit number, and converting the second pre-signal into a second output image signal having the second bit number, and a data driver applying a data voltage corresponding to each of the first and second output image signals to the first and second subpixels, respectively.

This application claims priority to Korean Patent Application No. 10-2005-0123129, filed on Dec. 14, 2005 and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display (“LCD”) and method thereof. More particularly, the present invention relates to an LCD having improved color reproducibility and a method thereof.

(b) Description of the Related Art

Liquid crystal displays (“LCDs) are one of the most widely used flat panel displays. LCDs include a pair of panels including pixel electrodes and a common electrode and a liquid crystal (“LC”) layer interposed between the panels and having dielectric anisotropy. The LCD generates electric fields in the LC layer by applying voltages to the electrodes, and obtains desired images by controlling the strength of the electric fields to vary the transmittance of light incident on the LC layer.

LCDs further include a switching element connected to each pixel electrode, and a plurality of signal lines, such as gate lines and data lines, to apply a voltage to a pixel electrode to control the switching element.

An image signal of a color such as red, green, or blue is input from an external graphics source to an LCD. A signal controller of an LCD appropriately processes the image signal, and provides the processed image signal to a data driver formed from an integrated circuit (“IC”). The data driver selects an analog gray voltage corresponding to the applied image signal and applies the selected analog gray voltage to a liquid crystal panel assembly.

Generally, it is preferable that the number of bits of an image signal input to a signal controller is the same as the number of bits to be processed by a data driver. Practically, a low processing data driver may be used to lower the manufacturing cost of LCDs. For example, in the case that an image signal to be applied to a signal controller is 10 bits, a low processing data driver such as a data driver processing an 8-bit image signal is used to lower the manufacturing cost, because a data driver processing a 10-bit image signal is relatively expensive.

That is, in order to represent a color having a greater bit number with a data driver processing less bit numbers, a method for increasing the number of cases or a method of temporally combining several frame units and representing a mid-point thereof by spatially combining several pixels and thus surrendering resolution has been used. However, the method has problems such as low resolution and degradation of definition due to flicker.

### BRIEF SUMMARY OF THE INVENTION

Thus, the present invention provides a liquid crystal display (“LCD”) and a method thereof to improve color reproducibility of a display device by increasing the number of representative colors without definition degradation, while a driver of a display device is not changed.

According to exemplary embodiments of the present invention, an LCD includes a liquid crystal (“LC”) panel assembly including a plurality of pixels, each having first and second subpixels, an image signal converter dividing an input image signal having a first bit number into a first pre-signal and a second pre-signal each having a second bit number less than the first bit number, and converting the first pre-signal into a first output image signal having the second bit number, and converting the second pre-signal into a second output image signal having the second bit number, and a data driver applying data voltages corresponding to the first and second output image signals to the first and second subpixels, respectively.

The first output image signal may correspond to the data voltage applied to the first subpixel, and the second output image signal may correspond to the data voltage applied to the second subpixel.

The first output image signal may be the first pre-signal added to a first correction value, and the second output image signal may be the second pre-signal added to a second correction value.

The image signal converter may include first and second lookup tables storing the first and second pre-signals, respectively, and third and fourth lookup tables storing the first and second correction values, respectively. Alternatively, the image signal converter may include first and second lookup tables storing the first and second output image signals, respectively.

The data voltage applied to the first subpixel and the data voltage applied to the second subpixel may be different from each other. Also, an area of the first subpixel and an area of the second subpixel may be different from each other, and the area of the first subpixel may be less than the area of the second subpixel, and the data voltage applied to the first subpixel may be higher than the data voltage applied to the second subpixel. For example, a ratio of the areas of the first and second subpixels may be within a range of 1:1.8 to 1:2.

The first and second subpixels may receive different data voltages that are obtained from single image information.

The first subpixel may have a first subpixel electrode, and the second subpixel may have a second subpixel electrode. In this case, the LCD may further include a first thin film transistor (“TFT”) connected to the first subpixel electrode, a second TFT connected to the second subpixel electrode, a first signal line connected to the first TFT, a second signal line connected to the second TFT, and a third signal line connected to the first and second TFTs, while intersecting the first and second signal lines.

The first and second TFTs may be turned on in response to signals of the first and second signal lines, respectively, and transmit a signal from the third signal line.

The first and second TFTs may be turned on in response to a signal of the third signal line, and transmit signals of the first and second signal lines.

The LCD may further include a signal controller controlling the data driver, and the signal controller may include the image signal converter.

According to other exemplary embodiments of the present invention, a method of improving color reproducibility of a display device is provided, where the display device includes a data driver processing a lower bit image signal than an image signal applied to a signal controller of the display device. The method includes providing an input image signal having a first number of bits, dividing the input image signal into first and second pre-signals having a second number of bits less than the first number of bits, applying correction values to the first and second pre-signals to form first and second output image signals, respectively, and applying the first and second output image signals to the data driver.

Dividing the input image signal into first and second pre-signals may include deleting a selected number of lower bits of the input image signal, and the method may further include storing the first and second pre-signals in first and second lookup tables, respectively.

Applying correction values to the first and second pre-signals may include includes adding first and second correction values to the first and second pre-signals, respectively, wherein the first and second correction values are based on the first number of bits.

The first and second pre-signals may be stored in first and second lookup tables, and the first and second correction values may be stored in third and fourth lookup tables, respectively, and the method may further include providing the first and second pre-signals and the first and second correction values to first and second adders, respectively.

The method may further include applying data voltages from the data driver to first and second subpixels of a pixel of the display device, the data voltages corresponding to the first and second output image signals, respectively.

According to other exemplary embodiments of the present invention, a method of improving color reproducibility of a display device is provided, where the display device includes a data driver processing a lower bit image signal than an image signal applied to a signal controller of the display device. The method includes providing an input image signal having a first number of bits, dividing the input image signal into first and second output signals having a second number of bits less than the first number of bits, the first and second output signals generated in consideration of correction values, and applying the first and second output image signals to the data driver. The method may further include storing the first and second output signals in first and second lookup tables prior to applying the first and second output image signals to the data driver.

### BRIEF DESCRIPTION OF THE DRAWINGS

The present invention will become more apparent by further describing exemplary embodiments thereof with reference to the accompanying drawings, in which:

FIG. 1 is a block diagram of an exemplary liquid crystal display (“LCD”) according to an exemplary embodiment of the present invention;

FIG. 2 is an equivalent circuit diagram of two exemplary subpixels of a LCD according to an exemplary embodiment of the present invention;

FIG. 3 is an equivalent circuit diagram of an exemplary pixel of an exemplary liquid crystal panel assembly according to an exemplary embodiment of the present invention;

FIG. 4 is a layout view of an exemplary liquid crystal panel assembly according to an exemplary embodiment of the present invention;

FIG. 5 and FIG. 6 are cross-sectional views of the exemplary liquid crystal panel assembly shown in FIG. 4, taken along lines V-V and VI-VI, respectively;

FIG. 7 is a graph illustrating luminance to gray in first and second exemplary subpixels of an exemplary LCD;

FIG. 8 is a graph illustrating a change of an exemplary image signal in an exemplary LCD.

FIG. 9A is a block diagram of an exemplary image signal converter of an exemplary LCD according to an exemplary embodiment of the present invention;

FIG. 9B is a block diagram of an exemplary image signal converter of an exemplary LCD according to another exemplary embodiment of the present invention;

FIG. 10 is a diagram of an exemplary lookup table for storing correction values of an exemplary LCD according to an exemplary embodiment of the present invention; and,

FIG. 11 is an equivalent circuit diagram of an exemplary pixel of an exemplary LCD assembly according to another exemplary embodiment of the present invention.

### DETAILED DESCRIPTION OF THE INVENTION

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A liquid crystal display (“LCD”) according to an exemplary embodiment of the present invention will now be described in detail by referring to the accompanying drawings.

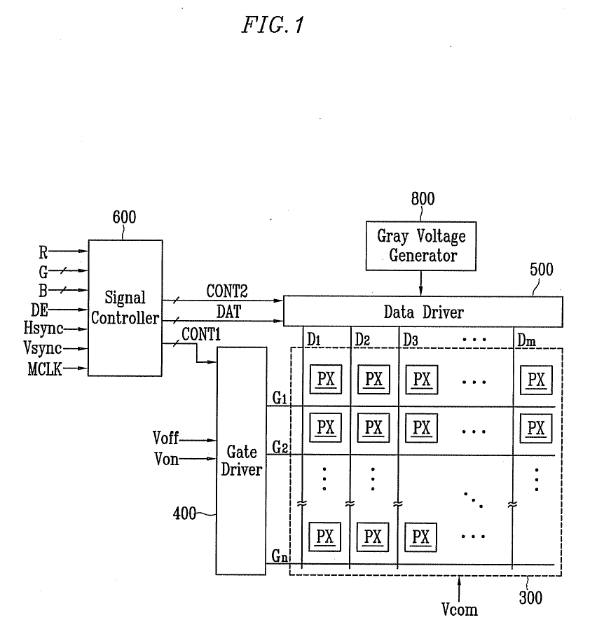

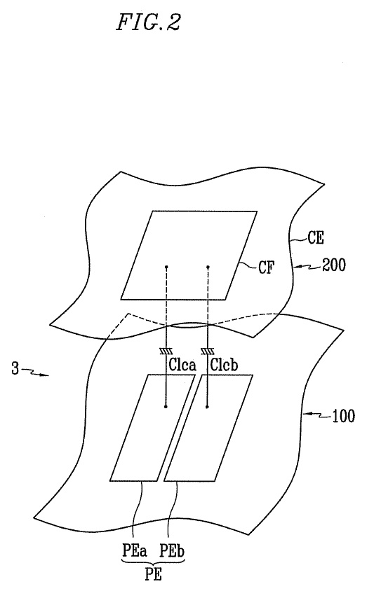

Referring to FIG. 1 and FIG. 2, an LCD according to an exemplary embodiment of the present invention is illustrated.

FIG. 1 is a block diagram of an exemplary LCD according to an exemplary embodiment of the present invention, and FIG. 2 is an equivalent circuit diagram of an exemplary pixel of an exemplary LCD according to an exemplary embodiment of the present invention.

As shown in FIG. 1, an LCD according to an exemplary embodiment of the present invention includes a liquid crystal (“LC”) panel assembly 300, a gate driver 400 and a data driver 500 connected to the LC panel assembly 300, a gray voltage generator 800 connected to the data driver 500, and a signal controller 600 for controlling the above elements.

The LC panel assembly 300, in view of an equivalent circuit, includes a plurality of pixels PX, which are connected to a plurality of signal lines G₁-Gₙ and D₁-Dₘ and arranged in a matrix. In view of the structure shown in FIG. 2, the LC panel assembly 300 includes lower and upper panels 100 and 200 facing each other and a liquid crystal layer 3 disposed there between.

The signal lines G₁-Gₙ and D₁-Dₘ include a plurality of gate lines G₁-Gₙ for transmitting gate signals (also known as scanning signals) and a plurality of data lines D₁-Dₘ for transmitting data signals. The gate lines G₁-Gₙ extend in a row direction, a first direction, and are parallel to each other. The data lines D₁-Dₘ extend in a column direction, a second direction, and are parallel to each other. The first direction may be substantially perpendicular to the second direction.

Each pixel PX includes a pair of subpixels, and each subpixel includes LC capacitors Clca and Clcb. At least one of the two subpixels includes a switching element (not shown) connected to a gate line, a data line, and LC capacitors Clca and Clcb.

The LC capacitor Clca/Clcb includes a subpixel electrode PEa/PEb and a common electrode CE provided on an upper panel 200 as two terminals. The liquid crystal layer 3 disposed between the common electrode CE and the subpixel electrode PEa/PEb acts as a dielectric material. The subpixel electrodes PEa and PEb are separated from each other and form a pixel electrode PE. The common electrode CE is formed on the entire upper panel 200, or substantially the entire upper panel 200, and is supplied with a common voltage Vcom. The LC layer 3 has negative dielectric anisotropy, and LC molecules in the LC layer 3 may be oriented so that long axes of the LC molecules are perpendicular to the surfaces of the panels 100 and 200 in absence of electric field.

For color display, each pixel PX particularly represents one of a set of colors, such as primary colors, (spatial division) or each pixel PX alternatively represents the colors by a period of time (temporal division). As a result, a desired color is represented by a spatial and temporal sum of the colors. An example of a set of colors include red, green, or blue. FIG. 2 shows an example of spatial division. In FIG. 2, each pixel PX includes a color filter CF for representing one of the colors in the set of colors on an area of the upper panel 200. Alternatively, the color filter CF may be formed on or under the subpixel electrodes PEa and PEb of the lower panel 100.

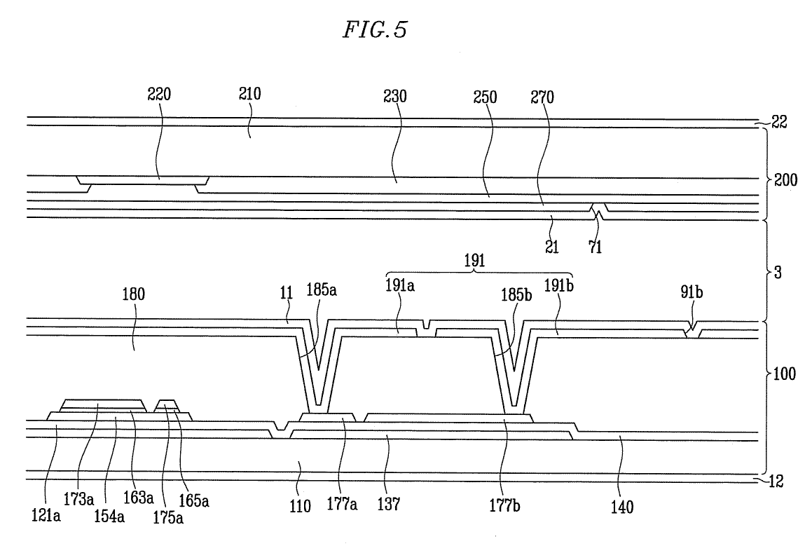

As will be later described with respect to FIG. 5, a pair of polarizers are attached to at least one of the panels 100 and 200. The polarization axis of the polarizers may be perpendicular to each other. In the case that an LCD is a reflective LCD, one of the two polarizers may be omitted. In the case that the polarizers are crossed polarizers, the polarizers cut off light input to the liquid crystal layer 3 when there is no electric field.

Referring to FIG. 1 again, the gray voltage generator 800 generates a plurality of gray voltages related to the transmittance of the pixels PX. However, the gray voltage generator 800 may generate only a given number of gray voltages (referred to as reference gray voltages) instead of generating all of the gray voltages.

The gate driver 400 is connected to the gate lines G₁-Gₙ of the LC panel assembly 300 and applies gate signals that are composed of a gate-on voltage Von and a gate-off voltage Voff to the gate lines G₁-Gₙ.

The data driver 500 is connected to the data lines D₁-Dₘ of the LC panel assembly 300, selects a gray voltage from the gray voltage generator 800 and applies the selected gray voltage as a data signal to the data lines D₁-Dₘ. In the case that the gray voltage generator 800 provides a predetermined number of the reference gray voltages, rather than all gray voltages, the data driver 500 divides the reference gray voltages, generates gray voltages for all grays, and selects a data signal among the generated gray voltages.

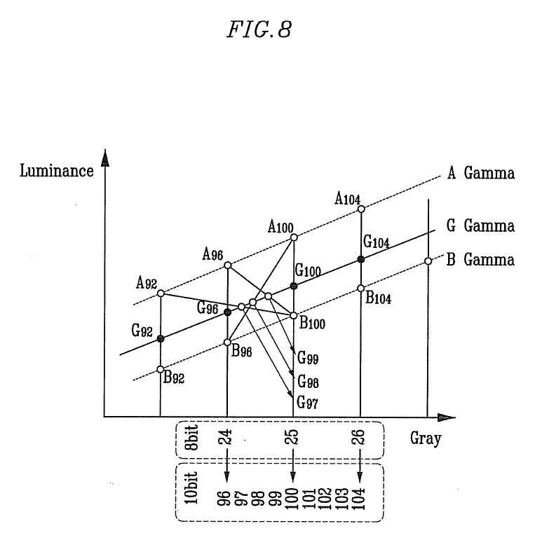

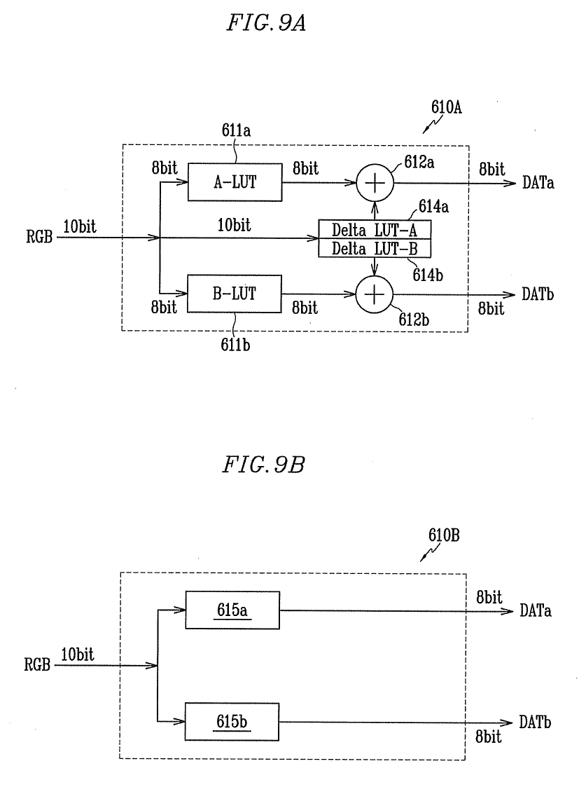

The signal controller 600 includes an image signal converter 610, as will be further described below with respect to FIGS. 9A and 9B, and controls the gate driver 400 or the data driver 500. The image signal converter 610 converts an image signal having a predetermined number of bits into an image signal having a different number of bits, such as a lesser number of bits.

Each of the driving apparatuses 400, 500, 600, and 800 may be directly installed on the LC panel assembly 300, as at least one integrated circuit (“IC”) chip. Each driving apparatus may be also installed on a flexible printed circuit (“FPC”) film (not shown), and as a tape carrier package (“TCP”) attached to the LC panel assembly 300 or an additional printed circuit board (“PCB”) (not shown). Alternatively, the driving apparatuses 400, 500, 600, and 800, along with the signal lines G₁-Gₙ and D₁-Dₘ and a thin film transistor (“TFT”) switching element Q, may be integrated in the LC panel assembly 300. As a further alternative, the driving apparatuses 400, 500, 600, and 800 may be integrated as a single chip, and in this case at least one or at least one circuit forming them may be located outside of the single chip.

Referring to FIG. 1 to FIG. 6, an exemplary structure of an LC panel assembly is illustrated in detail.

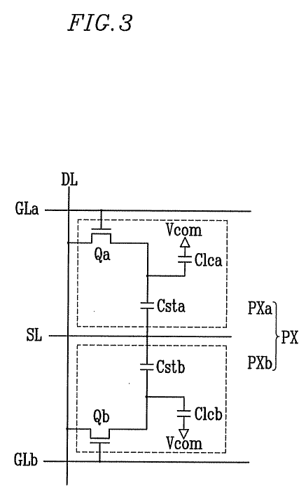

FIG. 3 is an equivalent circuit diagram of an exemplary pixel of an LC panel assembly according to an exemplary embodiment of the present invention.

Referring to FIG. 3, an LC panel assembly according to an exemplary embodiment of the present invention includes signal lines having a plurality of gate line pairs GLa and GLb, a plurality of data lines DL, and a plurality of storage electrode lines SL, and a plurality of pixels PX connected to the signal lines.

Each pixel PX has a pair of subpixels PXa and PXb. Each subpixel PXa/PXb has a switching element Qa/Qb connected to a corresponding gate line GLa/GLb and a data line DL, an LC capacitor Clca/Clcb connected to the switching element Qa/Qb, and a storage capacitor Csta/Cstb connected to the switching element Qa/Qb and a storage electrode line SL.

Each switching element Qa/Qb is a three-terminal element such as a thin film transistor (“TFT”), is provided on the lower panel 100, and has a control terminal, such as a gate electrode, connected to the gate line GLa/GLb, an input terminal, such as a source electrode, connected to the data line DL, and an output terminal, such as a drain electrode, connected to the LC capacitor Clca/Clcb and the storage capacitor Csta/Cstb.

The storage capacitor Csta/Cstb acts as an assistant of the LC capacitor Clca/Clcb and is formed by overlapping the storage electrode line SL and pixel electrode PE of the lower panel 100 with an insulator between them. A predetermined voltage, such as a common voltage Vcom, is applied to the storage line SL. Alternatively, the storage capacitors Csta and Cstb may be formed by overlapping the subpixel electrodes PEa and PEb and a previous gate line with an insulator between them.

Since the LC capacitors Clca and Clcb are described above, detailed descriptions thereof will be omitted.

In the LCD including the LC panel assembly, the signal controller 600 receives an input image signal R, G, or B for a single pixel PX, converts the input image signal into an output image signal DAT having a desired number of bits and corresponding to two subpixels PXa and PXb, and transmits the output image signal DAT to be supplied to the data driver 500. Otherwise, the gray voltage generator 800 generates separate groups of gray voltages for two subpixels PXa and PXb. The two groups of gray voltages are alternately supplied by the gray voltage generator 800 to the data driver 500 or alternately selected by the data driver 500 such that the two subpixels PXa and PXb are supplied with different voltages. At this time, the values of the converted output image signals and the values of the gray voltages in each group are preferably determined such that the synthesis of gamma curves for the two subpixels PXa and PXb approaches a reference gamma curve at a front view. For example, the synthesized gamma curve at a front view coincides with the most suitable reference gamma curve at a front view, and the synthesized gamma curve at a lateral view is most similar to the reference gamma curve at a front view.

Referring to FIG. 3 to FIG. 6, an example of the LC panel assembly shown in FIG. 3 is illustrated in detail.

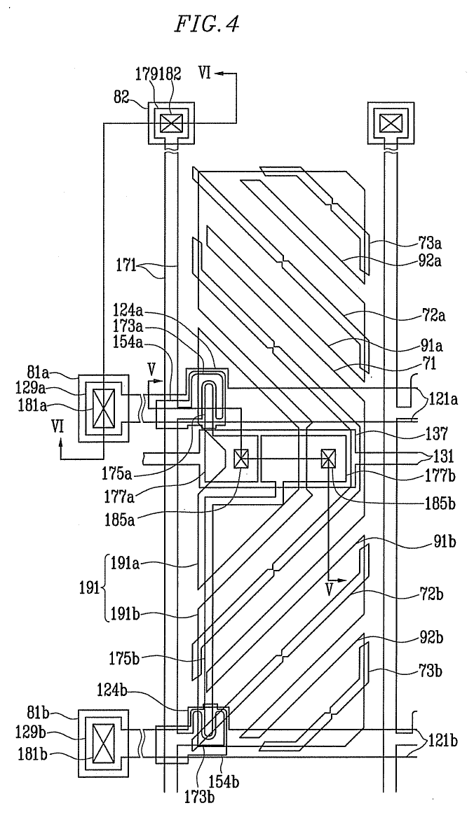

FIG. 4 is a layout view of an exemplary LC panel assembly according to an exemplary embodiment of the present invention. FIG. 5 and FIG. 6 are cross-sectional views of the exemplary LC panel assembly shown in FIG. 4, taken along lines V-V and VI-VI, respectively.

Referring to FIG. 4 to FIG. 6, an LC panel assembly according to an exemplary embodiment of the present exemplary includes a lower panel 100 and upper panel 200 facing each other, and an LC layer 3 disposed between the panels 100 and 200.

The lower panel 100 is illustrated as follows.

A plurality of gate conductors having a plurality of pairs of first and second gate lines 121a and 121b and a plurality of storage electrode lines 131 are formed on an insulation substrate 110 formed of, for example, transparent glass or plastic.

The first and second gate lines 121a and 121b transmit gate signals and extend in a transverse direction. The first gate line 121a is located above the second gate line 121b.

The first gate line 121a has an enlarged end portion 129a for making contact with a plurality of first gate electrodes 124a protruding downwardly, another layer, or the gate driver 400. The second gate line 121b has an enlarged end portion 129b for making contact with a plurality of second gate electrodes 124b protruding upwardly, another layer, or the gate driver 400. In the case that the gate driver 400 is integrated in the substrate 110, the gate lines 121a and 121b may extend and connect directly to the gate driver 400.

The storage electrode lines 131 are supplied with a predetermined voltage, such as a common voltage Vcom, and extend in a transverse direction. Each storage electrode line 131 is disposed between the first gate line 121a and the second gate line 121b. Each storage electrode line 131 expands upwardly or downwardly or both upwardly and downwardly, and has further extended storage electrodes 137, or may have pairs of storage electrodes for each pixel. The shape and arrangement of the storage electrodes 137 and storage electrode line 131 may be different.

The gate conductors 121a, 121b, and 131 may be formed from an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), or titanium (Ti). Alternatively, the gate conductors 121a, 121b, and 131 may have a multilayered structure composed of two conductive layers (not shown) of which physical properties are different from each other. One conductive layer may be formed from a low resistivity metal to reduce signal delay or voltage drop, such as an aluminum-based metal, a silver-based metal, or a copper-based metal. The other conductive layer may be formed from a material having excellent physical, chemical, or electrical contact characteristic with respect to another material such as indium tin oxide (“ITO”) and indium zinc oxide (“IZO”). A molybdenum-based metal, chromium, tantalum, and titanium are examples. Exemplary combinations of the two conductive layers include a combination of a chromium lower layer and an aluminum (alloy) upper layer, and a combination of an aluminum (alloy) lower layer and a molybdenum (alloy) upper layer. While particular examples have been described, the gate conductors 121a, 121b, and 131 may be formed from many other metals or conductors.

The lateral sides of the gate conductors 121a, 121b, 131 are inclined with respect to the surface of the substrate 110, and the inclined angle may be about 30° to about 80°.

A gate insulating layer 140, formed from silicon nitride (SiNx) or silicon oxide (SiOx), is formed on the gate conductors 121a, 121b, and 131 as well as on exposed portions of the substrate 110.

A plurality of first and second semiconductor islands 154a and 154b, formed from hydrogenated amorphous silicon (“a-Si”) or polysilicon, are formed on the gate insulating layer 140. The first and second semiconductors 154a and 154b are disposed on the first and second gate electrodes 124a and 124b, respectively.

A pair of ohmic contact island members 163a and 165a is formed on each of the first semiconductors 154a. Another pair of ohmic contact island members (not shown) is formed on each of the second semiconductors 154b. The ohmic contact members 163a and 165a, as well as the other pair of ohmic contact island members, may be formed from materials such as n+ hydrogenated a-Si on which an n-type impurity such as phosphorus is doped in a high concentration, or silicide.

The lateral sides of the semiconductors 154a and 154b and ohmic contact members 163a and 165a are inclined with respect to a surface of the substrate 110, and the inclined angle is about 30° to about 80°.

On the ohmic contact members 163a and 165a and the gate insulating layer 140, a data conductor having a plurality of data lines 171 and a plurality of pairs of first and second drain electrodes 175a and 175b is formed.

A data line 171 transmits a data signal and extends in a longitudinal direction, while intersecting the gate lines 121a and 121b and the storage electrode lines 131. The longitudinal direction of the data lines 171 may be substantially perpendicular to the transverse direction of the gate lines 121a and 121b. Each data line 171 has an enlarged end portion 179 for making contact with a plurality of pairs of first and second source electrodes 173a and 173b each extending toward the first and second gate electrodes 124a and 124b, another layer, or the data driver 500. In the case that the data driver 500 is integrated in the substrate 110, the data lines 171 may extend and connect directly to the data driver 500.

The first and second drain electrodes 175a and 175b are separated from each other, and at the same time, they are separated from the data lines 171. The first/second drain electrode 175a/175b faces the first/second source electrode 173a/173b with the first/second gate electrode 124a/124b between them, and has one enlarged end portion 177a/177b while the other end portion has a plate shape. The enlarged end portion 177a of the first drain electrode 175a has a larger area than that of the enlarged end portion 177b of the second drain electrode 175b. The enlarged end portions 177a and 177b overlap with the storage electrode 137, or overlap with the storage electrodes in a pair of storage electrodes for a pixel, respectively. The other end portions having a plate shape are partially surrounded with the curved first and second source electrodes 173a and 173b.

The first/second gate electrode 124a/124b, the first/second source electrode 173a/173b, and the first/second drain electrode 175a/175b, along with the first/second semiconductor 154a/154b, form a first/second TFT Qa/Qb. The first/second TFT Qa/Qb has a channel formed on the first/second semiconductor 154a/154b, which is disposed between the first/second source electrode 173a/173b and the first/second drain electrode 175a/175b. The first/second TFT Qa/Qb may be located on the right side of the data line 171.

The data conductors 171, 175a, and 175b may be formed from a refractory metal such as molybdenum, chromium, tantalum, and titanium, or an alloy thereof. The data conductors 171, 175a, and 175b may have a multilayered structure having a refractory metal layer (not shown) and a low resistance conductive layer (not shown). Exemplary multilayer structures may include a dual layer having a chromium or molybdenum (alloy) lower layer and an aluminum (alloy) upper layer, and a triple layer having a molybdenum (alloy) lower layer, an aluminum (alloy) middle layer, and a molybdenum (alloy) upper layer. While particular examples are described, the data conductors 171, 175a, and 175bmay be formed from many other metals or conductors.

The lateral sides of the data conductors 171, 175a, and 175b may be inclined with respect to the surface of the substrate 110. The inclined angle may be about 30° to about 80°.

The ohmic contact members 163a and 165a are disposed only between the semiconductors 154a and 154b disposed under the ohmic contact members 163a and 165a and the data conductors 171, 175a, and 175b disposed above the ohmic contact members 163a and 165a, and reduce contact resistance between them. The semiconductors 154a and 154b have exposed portions, for example an exposed portion between the source electrodes 173a and 173b and the drain electrodes 175a and 175b and an exposed portion that is not covered by the data conductors 171, 175a, and 175b.

A passivation layer 180 is formed on the data conductors 171, 175a, and 175b and the exposed portion of the semiconductors 154a and 154b, as well as on exposed portions of the gate insulating layer 140. The passivation layer 180 may be formed from an inorganic insulating material or an organic insulating material, and may be flat. The organic insulating material may have photosensitivity. The dielectric constant of the organic insulating material may be, for example, about 4.0 or less. Alternatively, the passivation layer 180 may have a dual-layer structure having a lower inorganic layer and an upper organic layer in order to maintain the excellent insulating characteristic of an organic layer, as well as preventing the exposed portion of the semiconductors 154a and 154b from being damaged.

A plurality of contact holes 182, 185a, and 185b for respectively exposing the end portions 179 of the data lines 171 and the enlarged end portions 177a and 177b of the drain electrodes 175a and 175b are formed through the passivation layer 180. A plurality of contact holes 181a and 181b for exposing the end portions 129a and 129b of the gate lines 121a and 121b are formed through the passivation layer 180 and the gate insulating layer 140.

A plurality of pixel electrodes 191 and a plurality of contact assisting members 81a, 81b, and 82 are formed on the passivation layer 180. The pixel electrodes 191 and the contact assisting members 81a, 81b, and 82 may be formed from a transparent conductive material such as ITO or IZO, or a reflective material such as aluminum, silver, chromium, or an alloy thereof.

Each pixel electrode 191 has first and second subpixel electrodes 191a and 191b separated from each other. The first and second subpixel electrodes 191a and 191b have different areas. The ratio of the areas of the first and second subpixel electrodes 191a and 191b may be about 1:1.8 to 1:2.

The first subpixel electrode 191a has a vertical side substantially parallel to the data line 171, and a pair of curved sides forming an oblique angle with respect to the gate line 121. The first subpixel electrode 191a has a chevron shape. The pair of curved sides has a concave left side meeting the gate line 121a while forming an acute angle with respect to the gate line 121a, and a convex right side meeting a horizontal side while forming an obtuse angle with respect to the horizontal side. The curved sides of the first subpixel electrode 191a are inclined with respect to the gate line 121a by an angle of about 45°. The edges of the pair of curved sides are chamfered. The first subpixel electrode 191a is symmetrically reversed with respect to the storage electrode line 131 traversing the center of the pixel electrode 191 and dividing the pixel electrode 191 into two parts.

The second subpixel electrode 191b is adjacent to the first subpixel electrode 191a in a row direction. The first subpixel electrode 191a is nested within, but spaced from, the second subpixel electrode 191b. The second subpixel electrode 191b has four major edges substantially parallel to the gate line 121 or the data line 171. The left edge of the second subpixel electrode 191b is chamfered. The chamfered oblique edges of the pixel electrode 191 is inclined with respect to the gate line 121 by an angle of about 45°. The second subpixel electrode 191b has a curved portion formed on the side adjacent to the first subpixel electrode 191a and substantially parallel to the curved portion of the first subpixel electrode 191a.

The second subpixel electrode 191b has a first upper cutout 91a, a first lower cutout 91b, a second upper cutout 92a, and a second lower cutout 92b, and is partitioned into a plurality of regions by the cutouts 91a-92b. The cutouts 91a-92b are symmetrically reversed with respect to the storage electrode line 131 bisecting the pixel electrode 191.

The lower and upper cutouts 91a-92b slant and extend from the left side of the pixel electrode 191 to the right side of the pixel electrode 191, and are located at lower and upper parts of the storage electrode line 131, respectively. The lower and upper cutouts 92a and 92b are inclined with respect to the gate line 121 by an angle of about 45°, and extend in a vertical direction.

The lower portion of the second subpixel electrode 191b is partitioned in three regions by the first and second lower cutouts 91b and 92b, and the upper portion of the second subpixel electrode 191b is partitioned in three regions by the first and second upper cutouts 91a and 92a. The number of partitioned regions or the number of cutouts may depend on design factors, such as the size of the pixel electrode 191, a length ratio of the horizontal side and vertical side of the pixel electrode 191, or the type or characteristics of the LC layer 3.

The first subpixel electrode 191a is connected to the enlarged portion 177a of the first drain electrode 175a through the contact hole 185a, and the second subpixel electrode 191b is connected to the enlarged portion 177b of the second drain electrode 175b through the contact hole 185b. The first and second subpixel electrodes 191a and 191b receive data voltages from the drain electrodes 175a and 175b, respectively. The first subpixel electrode 191a to which the data voltage is applied, along with the common electrode 270 of a common electrode panel 200 to which a common voltage is applied, forms an electric field, thereby determining the direction of the LC molecules of the LC layer 3 disposed between the two electrodes 191a and 270. According to the determined direction of the LC molecules, the polarization of the light passing though the LC layer 3 is changed. The pixel electrode 191 and the common electrode 270 form a capacitor, and maintain an applied voltage even if a TFT is turned off. The pixel electrode 191 and the common electrode 270 may be referred to as field generating electrodes.

The second subpixel electrode 191b and the second drain electrode 175b connected to the second subpixel electrode 191b overlap with the storage electrode 137 with the gate insulating layer 140 between them, and form a storage capacitor Cst.

The storage capacitor Cst enforces the voltage storing ability of the LC capacitor Clca/Clcb.

The contact assisting members 81a, 81b and 82 are connected to the end portions 129a, 129b of the gate lines 121a, 121b and the end portion 179 of the data line 171 through the contact holes 181a, 181b, and 182, respectively. The contact assisting members 81a, 81b, and 82 protect and compensate the contact between the end portions 129a, 129b, and 179 of the gate and data lines 121a, 121b, and 171 and an external device.

Next, the upper panel 200 will be described. A light blocking member 220 is formed on an insulation substrate 210 formed from, for example, transparent glass or plastic. The light blocking member 220 may have curved portions (not shown) corresponding to the curved sides of each pixel electrode 191 and quadrangle portions (not shown) corresponding to each TFT. The light blocking member 220 prevents light leakage between the pixel electrodes 191, and defines openings facing each pixel electrode 191.

A plurality of color filters 230 are formed on the substrate 210 and the light blocking member 220. The color filters 230 are mostly located in regions surrounded by the light blocking member 220, and they may become lengthy by extending along an array of the pixel electrodes 191. Each color filter 230 may represent one of three colors, such as red, green, and blue.

An overcoat 250 is formed on the color filters 230 and the light blocking member 220. The overcoat 250 may be formed from an organic insulating material, and it prevents the color filter 230 from being exposed and provides an even surface. In alternative embodiments, the overcoat 250 may be omitted.

A common electrode 270 is formed on the overcoat 250. The common electrode 270 is formed from a transparent conductor, such as ITO or IZO, and has a plurality of cutouts 71-73b.

The set of cutouts 71, 72a, 72b, 73a, and 73b faces one pixel electrode 191, and includes a first cutout 71, a first upper cutout 72a, a first lower cutout 72b, a second upper cutout 73a, and a second lower cutout 73b. Each of the cutouts 71-73b is disposed on the common electrode 270 at locations between adjacent cutouts 91a-92b of the pixel electrode 191, between the adjacent cutouts 91a-91b of the pixel electrode 191, or between the first and second subpixel electrodes 191a and 191b. Each of the cutouts 71-73b has at least one slanting portion extending substantially in parallel to the cutouts 91a-92b of the pixel electrode 191. Each slanting portion has at least one scooped notch. The cutouts 71-73b are symmetrically reversed with respect to the storage electrode line 131.

The number of the cutouts 71-73b may be different depending on design factors. The light blocking member 220 may overlap with the cutouts 71-73b and prevent light leakage adjacent to the cutouts 71-73b.

Alignment layers 11 and 21 are formed on insides of the panels 100 and 200, respectively, adjacent to the LC layer 3. The alignment layers 11 and 21 may include a vertical alignment layer.

Polarizers 12 and 22 are installed on outsides of the panels 100 and 200, respectively. The polarization axes of the two polarizers 12 and 22 are perpendicular to each other and are inclined with respect to the oblique sides of the subpixel electrodes 191a and 191b by an angle of about 45°. When an LCD is a reflective LCD, one of the two polarizers may be omitted.

An LCD may include a backlight unit (not shown) for providing the polarizers 12 and 22, a phase delay layer, the panels 100 and 200, and the LC layer 3 with light.

The LC layer 3 has negative dielectric anisotropy. The LC molecules of the LC layer 3 are arranged such that the longitudinal axes of the LC molecules are perpendicular to the surfaces of the two panels 100, 200 when an electric field does not exist.

The cutouts 71-73b may be replaced with protrusions (not shown) or depressions (not shown). The protrusions may be formed from an organic material or an inorganic material, and may be disposed above or below the field generating electrodes 191 and 270.

Referring to FIG. 1 to FIG. 6, an operation of an LCD is illustrated.

A signal controller 600 receives input image signals R, G, and B and an input control signal for controlling the representation of the image signals R, G, and B from an external graphics controller (not shown). The input image signals R, G, and B have luminance information for each pixel PX. The luminance has a predetermined number of grays, for example 1024 (2¹⁰), 256 (2⁸), or 64 (2⁶). The input control signal has, for example, a vertical synchronization signal Vsync, a horizontal synchronizing signal Hsync, a main clock signal MCLK, or a data enable signal DE.

The signal controller 600 processes the input image signals R, G, and B based on the input control signal and the input image signals R, G, and B, according to the operating conditions of the LC panel assembly 300 and the data driver 500, generates a gate control signal CONT1 and a data control signal CONT2, and applies the gate control signal CONT1 to the gate driver 400 and the data control signal CONT2 and processed image signal DAT to the data driver 500. The output image signal DAT is a digital signal and has a predetermined number of values (grays).

The signal processing of the signal controller 600 includes the image signal converter 610, as will be further described below, converting the input image signals R, G, and B having a predetermined number of bits into the output image signal DAT having a different number of bits from the predetermined number of bits by the image signal converter 610. For example, the image signal converter 610 converts an input image signal of 10 bits to an output image signal DAT of 8 bits.

The signal conversion of the image signal converter 610 will be described below.

The gate control signal CONT1 has a scanning start signal STV for indicating a scanning start and at least one clock signal for controlling an output period of a gate-on voltage Von. The gate control signal CONT1 may further include an output enable signal OE for limiting a lasting time of the gate-on voltage Von.

The data control signal CONT2 includes a horizontal synchronization start signal STH for indicating a transmit start of image data with respect to a bundle of pixels PX, a load signal LOAD for applying a data signal Vd to the LC panel assembly 300, and a data clock signal HCLK. The data control signal CONT2 may further include an inversion signal RVS for inverting the voltage polarity of a data signal Vd with respect to a common voltage Vcom (hereinafter, the voltage polarity of the data signal with respect to the common voltage is abbreviated as “a polarity of a data signal”).

In response to the data control signal CONT2 of the signal controller 600, the data driver 500 receives a digital image signal DAT corresponding to a bundle of pixels PX, selects a gray voltage corresponding to each digital image signal DAT, converts the digital image signal DAT into an analog data signal, and applies the analog data signal to a corresponding one of the data lines 171.

The gate driver 400 applies the gate-on voltage Von to the gate lines 121a and 121b in response to the gate control signal CONT1 of the signal controller 600, and turns on the switching elements Qa and Qb connected to the gate lines 121a and 121b.

Then, the data signal Vd applied to the data line 171 is applied to corresponding subpixels PXa and PXb through the turned on switching elements Qa and Qb.

As a result, a potential difference is formed at both ends of the LC capacitors Clca and Clcb, and a primary electric field that is substantially perpendicular to the surfaces of the panels 100 and 200 is formed on the LC layer 3. The longitudinal axes of the LC molecules of the LC layer 3 are inclined to be perpendicular to the direction of the electric field, in response to the electric field, and the polarization change of the input light of the LC layer 3 is changed depending on the inclined angle of the LC molecules. The polarization change is represented as transmittance change through a polarizer, and thus an LCD displays an image.

The inclined angle of the LC molecules depends on the strength of the electric field. Since the voltages of the two LC capacitors Clca and Clcb are different, the inclined angle of the LC molecules is different and the luminance of two subpixels is different. Thus, if the voltages of the first and second LC capacitors Clca and Clcb are properly controlled, the image viewed at a side is closest to the image viewed at a front. Particularly, a side gamma curve is closest to a front gamma curve, and thus side visibility is improved.

If the area of the first subpixel electrode 191a on which a high voltage is applied is smaller than the area of the second subpixel electrode 191b, the side gamma curve is almost identical to the front gamma curve. Particularly, when a ratio of the areas of the first and second subpixel electrodes 191a and 191b is about 1:1.8 to 1:2, the side gamma curve is virtually identical to the front gamma curve, and side visibility is further improved.

The direction in which the LC molecules are inclined is primarily determined by a horizontal element made by distortion of the primary electric field by the cutouts 71-73b and 91-92b of the field generating electrodes 191 and 270 and the sides of the subpixel electrodes 191a and 191b. The horizontal element of the primary electric field is substantially perpendicular to the sides of the cutouts 71-73b and 91-92b and the sides of the subpixel electrodes 191a and 191b.

The subpixel electrodes 191a and 191b are divided into a plurality of sub-regions by the cutouts 71-73b and 91a-92b. Each sub-region has two major edges defined by the curved portions of the cutouts 71-73b and 91a-92b and the curved sides of the subpixel electrodes 191a and 191b. The LC molecules located on each sub-region are mostly perpendicularly inclined to the major edges, and thus the inclined directions are four. Thus, when the inclined directions of the LC molecules are varied, the reference viewing angle of an LCD becomes greater.

A secondary electric field further generated by the voltage difference between the subpixel electrodes 191a and 191b has a direction perpendicular to the major edges of the sub-regions. Thus, the direction of the secondary electric field is the same as the direction of the horizontal element of the primary electric field. The secondary electric field between the subpixel electrodes 191a and 191b enhances the determination of the inclined direction of the LC molecules.

The above process is repeated by a unit of 1 horizontal period (“1H”) that is identical to one period of the horizontal synchronizing signal Hsync and the data enable signal DE, and all pixels PX receive data signals to display an image of a frame.

After one frame is completed, a next frame starts. The inversion signal RVS to be applied to the data driver 500 is controlled such that the data signal applied to each pixel PX has an opposite polarity to the polarity of the data signal applied to the pixel of a previous frame (“frame inversion”). Within one frame, the data signal passing along a data line 171 may change its polarity according to the characteristic of the inversion signal RVS (for example, row inversion or dot inversion), or the data signals applied to a bundle of pixels PX may have different polarities (for example, column inversion or dot inversion).

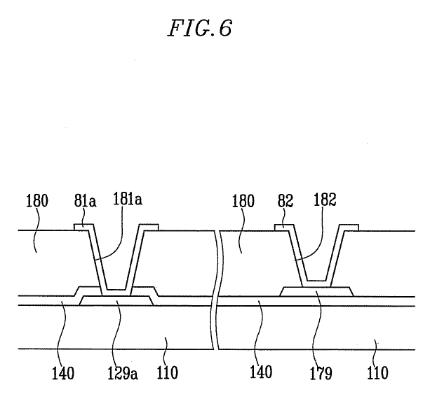

Referring to FIG. 7 to FIG. 10, signal processing of an exemplary LCD according to an exemplary embodiment of the present invention is illustrated.

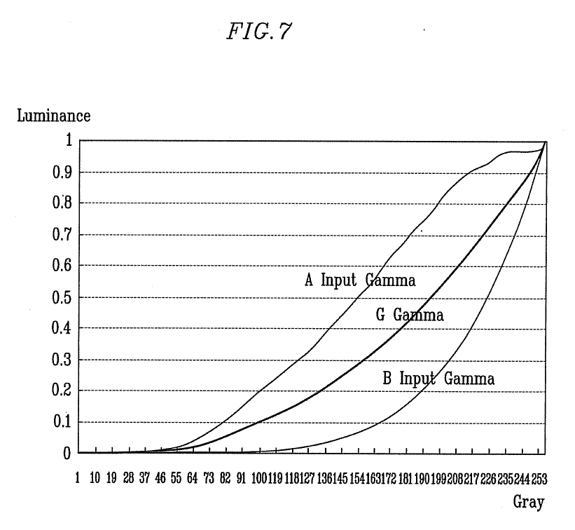

Referring to FIG. 7 and FIG. 8, an exemplary method for converting an image signal according to an exemplary embodiment of the present invention is illustrated.

FIG. 7 is a graph illustrating luminance to gray of first and second exemplary subpixels and all pixels of an exemplary LCD. FIG. 8 is a graph illustrating an exemplary method for converting an image signal according to an exemplary embodiment of the present invention.

FIG. 7 shows a target gamma curve (G Gamma), a first gamma curve (A Gamma), and a second gamma curve (B Gamma). Referring to the gamma curves G Gamma, A Gamma, and B Gamma, gray is one to one correspondence to luminance. The first gamma curve, A Gamma, shows luminance to gray of the first subpixel electrode 191a, and the second gamma curve, B Gamma, shows luminance to gray of the second subpixel electrode 191b. The first and second gamma curves, A Gamma and B Gamma, are determined such that an average of voltages applied to the first and second subpixel electrodes 191a and 191b is the target voltage of the entire pixel electrode 191.

Referring to FIG. 8, a target gamma curve (G Gamma), the first gamma curve (A Gamma), and the second gamma curve (B Gamma) adjacent to gray nos. 24, 25, and 26 among the 8-bit grays, are shown. In comparison of an 8-bit gray and a 10-bit gray, gray nos. 24, 25, and 26 of the 8-bit gray correspond to nos. 96, 100, and 104 grays of the 10-bit gray, respectively. Between each gray of the 8-bit grays, there are three grays that are represented in 10-bit but are not represented in 8-bit. For example, between gray nos. 24 and 25 of the 8-bit grays, there are gray nos. 97, 98, and 99 of the 10-bit grays. The grays that cannot be represented in 8-bit, for example gray nos. 97, 98, 99 of the 10-bit grays may be represented by synthesizing the values of the first gamma curve (A Gamma) and second gamma curve (B Gamma). Thus, by appropriately synthesizing the voltages of the first subpixel electrode 191a and second subpixel electrode 191b, a greater number of colors can be represented by the same number of driving apparatuses.

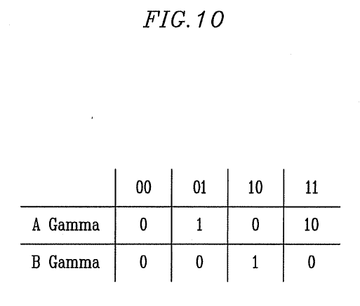

Referring to FIG. 9A to FIG. 10, an exemplary method for representing the greater number of colors with the first and second subpixels, as in FIG. 8, is illustrated in detail.

FIG. 9A and FIG. 9B are block diagrams each illustrating an exemplary image signal converter of an exemplary LCD according to an exemplary embodiment of the present invention, and FIG. 10 shows an exemplary lookup table for storing a correction value used for image signal conversion of an exemplary LCD according to an exemplary embodiment of the present invention.

Referring to FIG. 9A, the image signal converter 610A of the signal controller 600 includes first and second lookup tables 611a and 611b for storing first and second pre-signals, third and fourth lookup tables 614a and 614b for storing first and second correction values, a first adder 612a for adding the first correction value from the third lookup table 614a to the first pre-signal stored in the first lookup table 611a, and a second adder 612b for adding the second correction value from the fourth lookup table 614b to the second pre-signal stored in the second lookup table 611b.

When the signal controller 600 receives, as an example, an input image signal R, G, or B of 10 bits, the image signal converter 610A divides the input image signal R, G, or B into the first and second pre-signals of, for example, 8 bits. The divided first and second pre-signals are stored in the first and second lookup tables 611a and 611b, respectively, and are then output to the first and second adders 612a and 612b, respectively. The first and second correction values stored in the third and fourth lookup tables 614a, 614b are determined based on 10 bits, that is, the same number of bits of the input image signal R, G, or B, and the determined first and second correction values are output from the third and fourth lookup tables 614a, 614b to the first and second adders 612a and 612b. The first adder 612a adds the first pre-signal to the first correction value to output a first output image signal DATa, which is applied to the data driver 500. The second adder 612b adds the second pre-signal to the second correction value to output a second output image signal DATb, which is applied to the data driver 500.

While the image signal converter 610A shown in FIG. 9A separately adds the first and second correction values to the first and second pre-signals, the image signal converter 610B shown in FIG. 9B instead divides the input image signal R, G, or B of 10 bits by two image signals of 8 bits, considering the correction values, and then generates the first and second output image signals. The first and second output image signals are stored in lookup tables 615a and 615b, respectively, and are then applied to the data driver 500.

Referring to FIG. 10, the determination of the first and second correction values in the image signal converters 610A and 610B shown in FIG. 9A and FIG. 9B is illustrated.

Still referring to FIG. 10, the first and second correction values according to the cases of 2 bits, for example 00, 01, 10, and 11, are stored in the lookup table. The signal controller 600 receives the input image signal R, G, or B of a 10-bit gray, for example, and represents the input image signal R, G, or B as a gray of 8 bits, for example, which is 2 bits less than 10 bits. Two lower bits of 10 bits are deleted and the first and second correction values stored in the lookup table of FIG. 10 are added to the input image signal R, G, or B of 8 bits, respectively.

When the input image signal R, G, or B is, for example, “0000001001”, the correction values stored in the lookup table of FIG. 10 replace two lower bits “01” of the input image signal R, G, or B, respectively. Still referring to FIG. 10, when two lower bits are “01”, the first correction value for the first gamma curve A Gamma is “1” and the second correction value for the second gamma curve B Gamma is “0”. Each correction value is added to the input image signal R, G, or B. Thus, the first output image signal DATa is “00000011 [=(00000010+1)]”, and the second output image signal DATb is “00000010 [=(00000010+0)]”. Thus, the input image signal R, G, or B of 10 bits is converted to the first and second output image signals DATa and DATb of 8 bits, which are applied to the data driver 500.

When one pixel is divided into first and second subpixels, as in an LCD according to an exemplary embodiment of the present invention, an input image signal having a greater number of bits than a number of bits that are processed by a data driver is represented by controlling a data voltage applied to the two subpixels.

The lookup table according to an exemplary embodiment of the present invention is not limited to the lookup table shown in FIG. 10, but can vary depending on the areas of the first and second subpixel electrodes 191a and 191b and an area per one gray.

Although an exemplary embodiment of the present invention illustrates the conversion of an input image signal of 10 bits into an output image signal of 8 bits, the conversion according to an exemplary embodiment of the present invention may convert an input image signal having various bit numbers into an output image signal having various other bit numbers.

Referring to FIGS. 1 and 2 and FIG. 11, an exemplary LC panel assembly according to another exemplary embodiment of the present invention is illustrated.

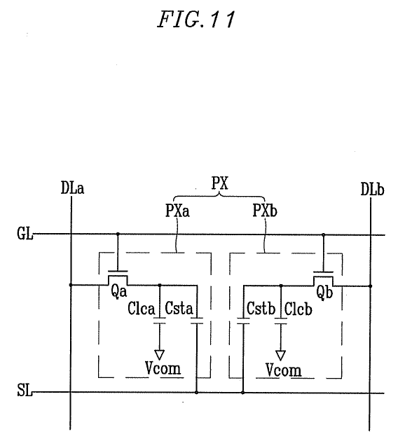

FIG. 11 is an equivalent circuit diagram of an exemplary pixel of an exemplary LC panel assembly according to an exemplary embodiment of the present invention.

Referring to FIG. 11, an LC panel assembly according to an exemplary embodiment of the present invention includes signal lines having a plurality of gate lines GL, a plurality of pairs of data lines DLa and DLb, and a plurality of storage electrode lines SL, and a plurality of pixels PX connected to the signal lines.

Each pixel PX has a pair of subpixels PXa and PXb. Each subpixel PXa/PXb has a switching element Qa/Qb connected to a corresponding gate line GL and data line DLa/DLb, an LC capacitor Clca/Clcb connected to the switching element Qa/Qb, and a storage capacitor Csta/Cstb connected to the switching element Qa/Qb and the storage electrode line SL.

Each switching element Qa/Qb is a three-terminal element, such as a TFT, installed on a TFT array panel, such as the lower panel 100 previously described, having a control terminal, such as a gate electrode, connected to the gate line GL, an input terminal, such as a source electrode, connected to the data line DLa/DLb, and an output terminal, such as a drain electrode, connected to the LC capacitor Clca/Clcb and the storage capacitor Csta/Cstb.

Since the LC capacitors Clca and Clcb and the storage capacitors Csta and Cstb and an operation of the LCD having the LC panel assembly, as shown in FIG. 11, are substantially identical to those as shown in FIGS. 1-10, a detailed description thereof is omitted. In the LCD shown in FIG. 3, the two subpixels Pxa and Pxb forming one pixel PX receive a data voltage with a time difference, while in the LCD shown in FIG. 11, the two subpixels Pxa and Pxb receive a data voltage at the same time.

According to an exemplary embodiment of the present invention, an LCD increases a number of representative colors and improves the color reproducibility of a display device without replacing a driving apparatus of the display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal panel assembly including a plurality of pixels, each pixel having first and second subpixels respectively;
an image signal converter dividing an input image signal having a first bit number into a first pre-signal and a second pre-signal each having a second bit number less than the first bit number, and converting the first pre-signal into a first output image signal having the second bit number and converting the second pre-signal into a second output image signal having the second bit number; and
a data driver applying data voltages corresponding to the first and second output image signals to the first and second subpixels, respectively.

2. The display of claim 1, wherein the first output image signal corresponds to the data voltage applied to the first subpixel, and the second output image signal corresponds to the data voltage applied to the second subpixel.

3. The display of claim 1, wherein the first output image signal is the first pre-signal added to a first correction value, and the second output image signal is the second pre-signal added to a second correction value.

4. The display of claim 3, wherein the image signal converter includes first and second lookup tables storing the first and second pre-signals, respectively, and third and fourth lookup tables storing the first and second correction values, respectively.

5. The display of claim 3, wherein the image signal converter includes first and second lookup tables storing the first and second output image signals, respectively.

6. The display of claim 1, wherein the data voltage applied to the first subpixel and the data voltage applied to the second subpixel are different from each other.

7. The display of claim 1, wherein an area of the first subpixel and an area of the second subpixel, within each pixel, are different from each other.

8. The display of claim 7, wherein the area of the first subpixel is less than the area of the second subpixel, and the data voltage applied to the first subpixel is higher than the data voltage applied to the second subpixel.

9. The display of claim 8, wherein a ratio of the areas of the first and second subpixels is within a range of 1:1.8 to 1:2.

10. The display of claim 9, wherein the data voltage applied to the first and second subpixels is originated from a single image information.

11. The display of claim 10, wherein, within each pixel, the first subpixel has a first subpixel electrode, and the second subpixel has a second subpixel electrode, and
the liquid crystal display further comprises:
a first thin film transistor connected to the first subpixel electrode;
a second thin film transistor connected to the second subpixel electrode;
a first signal line connected to the first thin film transistor;
a second signal line connected to the second thin film transistor; and
a third signal line connected to the first and second thin film transistors, while intersecting the first and second signal lines.

12. The display of claim 11, wherein the first and second thin film transistors are turned on according to signals from the first and second signal lines, respectively, and transmit signals from the third signal line.

13. The display of claim 11, wherein the first and second thin film transistors are turned on according to signals from the third signal line, and transmit signals of the first and second signal lines.

14. The display of claim 1, further comprising a signal controller controlling the data driver, the signal controller including the image signal converter.

15. A method of improving color reproducibility of a display device, the display device having a data driver processing a lower bit image signal than an image signal applied to a signal controller of the display device, the method comprising:
providing an input image signal having a first number of bits;
dividing the input image signal into first and second pre-signals having a second number of bits less than the first number of bits;
applying correction values to the first and second pre-signals to form first and second output image signals, respectively; and,
applying the first and second output image signals to the data driver.

16. The method of claim 15, wherein dividing the input image signal into first and second pre-signals includes deleting a selected number of lower bits of the input image signal, and further comprising storing the first and second pre-signals in first and second lookup tables, respectively.

17. The method of claim 15, wherein applying correction values to the first and second pre-signals includes adding first and second correction values to the first and second pre-signals, respectively, wherein the first and second correction values are based on the first number of bits.

18. The method of claim 17, wherein the first and second pre-signals are stored in first and second lookup tables, and the first and second correction values are stored in third and fourth lookup tables, respectively, and further comprising providing the first and second pre-signals and the first and second correction values to first and second adders, respectively.

19. The method of claim 15, further comprising applying data voltages from the data driver to first and second subpixels of a pixel of the display device, the data voltages corresponding to the first and second output image signals, respectively.

20. A method of improving color reproducibility of a display device, the display device having a data driver processing a lower bit image signal than an image signal applied to a signal controller of the display device, the method comprising:
providing an input image signal having a first number of bits;
dividing the input image signal into first and second output signals having a second number of bits less than the first number of bits, the first and second output signals generated in consideration of correction values; and,
applying the first and second output image signals to the data driver.

21. The method of claim 20, further comprising storing the first and second output signals in first and second lookup tables prior to applying the first and second output image signals to the data driver.
